(19) United States
(12) Patent Application Publication
(10) Pub. No.: US 2008/0160906 A1
(43) Pub. Date: Jul. 3, 2008

(54) DISCRETE MEDIA TRANSFER PROGRESS STATUS INDICATION

(75) Inventors: Ranjeev Ranjan, Carpentersville, IL (US); Balakumar Jagadesan, Glendale Heights, IL (US); Johanna A. Wild, Muenchen (DE)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/675,728

(22) Filed: Feb. 16, 2007

Related U.S. Application Data
(60) Provisional application No. 60/882,261, filed on Dec. 28, 2006.

(51) Int. Cl. H04H 1/00

(52) U.S. Cl. 455/3.01

(57) ABSTRACT

A method and information processing system provide discrete media transfer status information. The method includes receiving a discrete media transfer request (904) from a wireless device (104) including discrete media. A request for discrete media transfer status information is received. A request (912) for discrete media transfer status information is wirelessly sent to each receiving wireless device (106) in a group of wireless devices receiving the same media set. Discrete media transfer status information (914) is received from each of the receiving wireless devices (106). A current transfer status (916) associated with each receiving wireless device (106) is stored based on the discrete media transfer status information received from each receiving wireless device. Transfer status (918) for each receiving wireless device (106) is wirelessly sent to at least one wireless device of the group of receiving wireless devices.

### REFERENCE(S) TO RELATED APPLICATION(S)

The present application claims priority from a provisional application Ser. No. 60/882,261, entitled “DISCRETE MEDIA TRANSFER PROGRESS STATUS INDICATION,” filed Dec. 28, 2006, which is commonly owned and incorporated herein by reference in its entirety.

### FIELD OF THE INVENTION

The present invention generally relates to the field of wireless communications, and more particularly relates to monitoring and communicating discrete media transfer progress status associated with multiple wireless devices.

### BACKGROUND OF THE INVENTION

In the present day, wireless communication devices such as cellular phones are capable of transmitting/receiving multiple communication services such as push-to-talk (“PTT”) communications, cellular communications, and data communications. For example, wireless communication devices using a multi-mode network can make both PTT and cellular calls. PTT is a service for conversing over half-duplex communication lines, including two-way radio, by pushing a button to send a transmission and releasing the button to receive a transmission back. In other words, PTT allows a wireless communication device to operate as a two-way radio when in the PTT mode. Only one PTT user can transmit at a time but several users can receive the transmission at the same time.

More recently, push-to-talk over cellular (“PoC”) has become available to users of these multi-mode wireless communication devices. PoC is a wireless feature that allows wireless service subscribers to make direct, simultaneous radio voice connections over any packet data network. PoC is implemented on the IP back-bone, which allows any packet data service to provide PoC communications.

If a user wants to transfer discrete media during a PoC Session by reusing the mechanism specified for IM transfer, the PoC system generally uses a media session relay protocol “MSRP” for the transfer. MSRP allows for mechanisms defined for IM (Instant Messaging) Services to be reused for media transfer. It's probably worth mentioning. However, the MSRP protocol only allows for media transfer status to be reported for a single peer entity. This is problematic because during a group PoC call, two or more members can receive the same set of data. The media transfer status can only be shown for one peer and not multiple peers.

Therefore a need exists to overcome the problems with the prior art as discussed above.

### SUMMARY OF THE INVENTION

Briefly, in accordance with the present invention, disclosed are a method and information processing system for providing discrete media transfer status information associated with a discrete media transfer event between a discrete media source and at least one discrete media recipient. The method comprises receiving a discrete media transfer request from a wireless device comprising discrete media. A request for discrete media transfer status information is wirelessly sent to each receiving wireless device in a group of wireless devices receiving the same media set. Discrete media transfer status information is received from each of the receiving wireless devices. Current transfer status associated with each receiving wireless device is stored based on the discrete media transfer status information received from each receiving wireless device. Transfer status for each receiving wireless device is wirelessly sent to at least one wireless device of the group of receiving wireless devices.

In another embodiment, a method for displaying discrete media transfer progress status for each wireless device in a group of wireless devices receiving a substantially similar media set is disclosed. The method includes receiving discrete media transfer progress information associated with a plurality of wireless devices receiving a substantially similar media set. Discrete media transfer progress information for each wireless device in the plurality of wireless devices is displayed to a user through a user interface.

In yet another embodiment, an information processing system for providing discrete media transfer status information associated with a discrete media transfer event between a discrete media source and at least one discrete media recipient is disclosed. The information processing system comprises a memory and a processor that is communicatively coupled to the memory. The information processing system also includes a media transfer status module that is communicatively coupled to the memory and the processor, The media transfer status module is for receiving a discrete media transfer request from a wireless device comprising discrete media. A request for discrete media transfer status information is wirelessly sent to each receiving wireless device in a group of wireless devices receiving the same media set. Discrete media transfer status information is received from each of the receiving wireless devices. Current transfer status associated with each receiving wireless device is stored based on the discrete media transfer status information received from each receiving wireless device. Transfer status for each receiving wireless device is wirelessly sent to at least one wireless device of the group of receiving wireless devices.

One of the advantages of various embodiments of the present invention is that transfer progress status for a media set being transferred to each member of a receiving group using PoC can be displayed to the sender. Also, each receiving device can also receive transfer progress information associated with the other receivers. The media transfer progress information can be stored at the distribution point for immediate or later use.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a wireless communications systems according to an embodiment of the present invention;

FIG. 2 is a timing diagram illustrating a process for discrete media transfer progress indication using MSRP messages according to an embodiment of the present invention;

FIG. 3 is a timing diagram illustrating a process for discrete media transfer progress indication using SIP-INFO messages according to an embodiment of the present invention;

FIG. 4 is a timing diagram illustrating a process for discrete media transfer progress indication using MBCP (Media Burst Control Protocol) messages according to an embodiment of the present invention;

FIG. 5 is a timing diagram illustrating a process for discrete media transfer progress indication utilizing a SIP event package that monitors transfer progress according to an embodiment of the present invention;

FIG. 6 is a block diagram illustrating a graphical user interface for displaying media transfer progress to a user;

FIG. 7 is a block diagram illustrating a wireless communication device according to an embodiment of the present invention;

FIG. 8 is a block diagram illustrating a information processing system according to an embodiment of the present invention;

FIG. 9 is an operational flow diagram illustrating a process for discrete media transfer progress indication using MSRP messages according to an embodiment of the present invention;

FIG. 10 is an operational flow diagram illustrating a process for discrete media transfer progress indication using MSRP messages according to an embodiment of the present invention;

FIG. 11 is an operational flow diagram illustrating a process for discrete media transfer progress indication using a media burst control message according to an embodiment of the present invention;

FIG. 12 is an operational flow diagram illustrating a process for discrete media transfer progress indication using media transfer progress indication messages according to an embodiment of the present invention; and

FIG. 13 is an operational flow diagram illustrating a process of displaying media transfer progress information to a user according to an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term wireless communication device is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smartphone, a two-way radio, a two-way pager, a wireless messaging device, a laptop/computer, automotive gateway, residential gateway, and the like.

Wireless Communications System

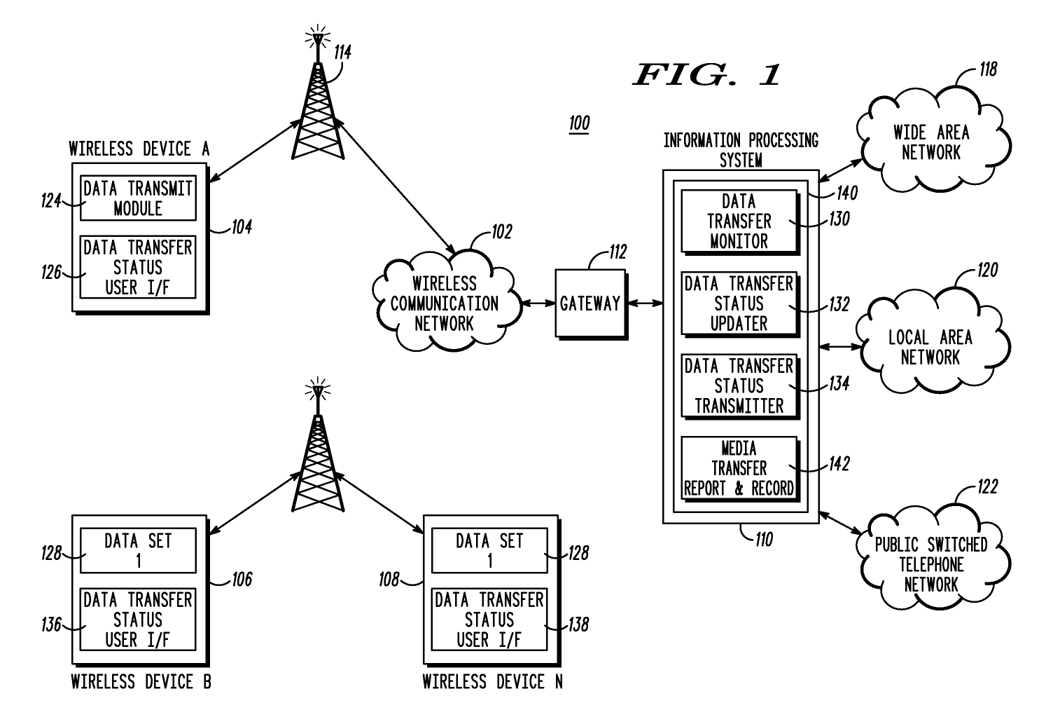

According to an embodiment of the present invention, as shown in FIG. 1, an example of a wireless communications system 100 is illustrated. FIG. 1 shows a wireless communications network 102 that connects wireless devices 104, 106, 108 with a central server 110 via a gateway 112. The wireless network 102 comprises a mobile phone network, a mobile text messaging device network, a pager network, or the like. Further, the communications standard of the wireless network 102 of FIG. 1 comprises Code Division Multiple Access (CDMA), Time Division Multiple Access (TDMA), Global System for Mobile Communications (GSM), General Packet Radio Service (GPRS), Frequency Division Multiple Access (FDMA), Wireless LAN (WLAN), WiMAX or the like. Additionally, the wireless communications network 102 also supports text messaging standards, for example, Short Message Service (SMS), Enhanced Messaging Service (EMS), Multimedia Messaging Service (MMS), or the like. The wireless communications network 102 also allows for PoC communications between the wireless devices 104, 106, 108.

The wireless network 102 supports any number of wireless devices 104, 106, 108. The wireless communication devices 104, 106, 108 can be either multi-mode devices or single mode devices. The support of the wireless network 102 includes support for mobile telephones, smart phones, text messaging devices, handheld computers, pagers, beepers, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities supporting additional communication services.

Additionally, the wireless devices 104, 106, 108 also include a local wireless link (not shown) that allows the wireless devices 104, 106, 108 to directly communicate with each other without using the wireless network 102. The local wireless link (not shown), for example, can be used for PTT communications. The local wireless link (not shown), in another embodiment, is provided by Bluetooth, Infrared Data Access (IrDA) technologies or the like. The central server 110 maintains and processes information for all wireless devices communicating on the wireless network 102.

The wireless communications system 100 also includes one or more base stations 114, 116. The wireless communication devices 104, 106, 108, in this example, are communicatively coupled to the wireless communications network 102 via the base stations 114, 116. Although FIG. 1 shows one wireless communication device 104 coupled to a different base station 114 than the other wireless devices 106, 108, each wireless device 104, 106, 108 can be coupled to the same or separate base stations 114, 116.

Additionally, the central server 108, in this example, communicatively couples the wireless devices 104, 106, 108 to a wide area network 118, a local area network 120, and a public switched telephone network 122 through the wireless communications network 102. Each of these networks 118, 120, 122 has the capability of sending data, for example, a multimedia text message to the wireless devices 104, 106, 108.

As discussed above, the wireless devices 104, 106, 108 can communicate using PoC. In the example of FIG. 1, the wireless device A 104 communicates with wireless device B 106 and wireless device N 108 using PoC to transfer data. In other words, wireless device A 104 performed a group PoC call, wherein the group included wireless device B 106, and wireless device N 108. The wireless device A 104 includes a data transmit module 124 and a data transfer status user interface 126. From here on in, the data to be transferred is referred to as media. The other wireless devices 106, 108 also include a data transmit module and a data transfer status user interface, which are not shown for clarity. The data transmit module 124 allows the wireless device A 104 to initiate a media transfer to a group of wireless devices such as wireless device B 106 and wireless device N 108. In other words, wireless device B 106 and wireless device C 108 receive the same set of media 128. In one embodiment, the media to be transferred and monitored is discrete media. Discrete media, for example, is media that is independent of time such as text, images, or the like

The media can be stored locally on the wireless device A 104 or can be stored on a remote system such as the information processing system (central server) 110. The data transfer status user interface 126 visually indicates to the user of the wireless device A 104 the media transfer status associated with each of the recipients (wireless device B 106 and wireless device N 108). Additionally, each recipient device 106, 108 can also include a data transfer status user interface 136, 138. In this example, each of the recipient wireless devices such as wireless device B 106 and wireless device N 108 can display the media transfer status of the other recipients to the user.

The central server 110 includes media transfer status module 140 collecting and reporting media transfer status information. The media transfer status module 140 includes a data transfer monitor 130, data transfer status updated 132, and data transfer status transmitter 134. It should be noted that these components can reside on a remote information processing system and not on the central server 110. When the central server 110 receives a media transfer request from a wireless device 104, the server 110 sets up a MSRP session with the receiving peer such as wireless device B 106 and wireless device N 108. In one embodiment, the server 110 sets up the MSRP session by setting a “success report” and “failure report” field in the header of the MSRP SEND message to “yes”. The server 110 also indicates the invocation of a progress status report in a header extension, e.g. “includes-progress-report”, “includes-final-report” etc. The server 110 creates MSRP send requests of a predefined or negotiated chunk size, which allows the server 110 to receive transfer status of each peer in multiples of the chunk size. The chunk size along with periodicity of status reporting, complete/optimized information reporting, and the like can either be defined by local policies of the network operator or by negotiating parameters in the SIP/SDP messages or headers in the MSRP messages.

Based on the received MSRP report messages, which include information associated with media transfer status of the corresponding peer, the data transfer status monitor 130 takes a snapshot of the current media transfer status for each peer. The data transfer status updater then updates a media transfer report record 142. This record can include MSRP session identification of the device sending the media, a time stamp, complete information such as a list of percentage/(number of data chunk) transfer complete per destination, list of completed transfers, list of failed transfers, and the like. The media transfer report record 142 can also include optimized information such as lowest percentage/(number of data chunk) transfer complete, number of transfers in progress, number of failed transfers, number of completed transfers, and the like.

In one embodiment, the data transfer status transmitter 134 sends MSRP media transfer status messages (i.e., MSRP messages) to device sending the data such as wireless device A 104. The data transfer status transmitter 134 can also send MSRP media transfer status messages to the peer devices receiving the media such as wireless device B 106 and wireless device N 108. The MSRP media transfer status messages can include media transfer status metrics, i.e., the media transfer report record 142, which includes media transfer information for all connected links. The MSRP media transfer status messages, in one embodiment, are sent based on a given policy define a transmission rate of periodic intervals, end of session, thresholds, and the like.

Timing Diagram For Providing Media Transfer Status using MSRP Messages

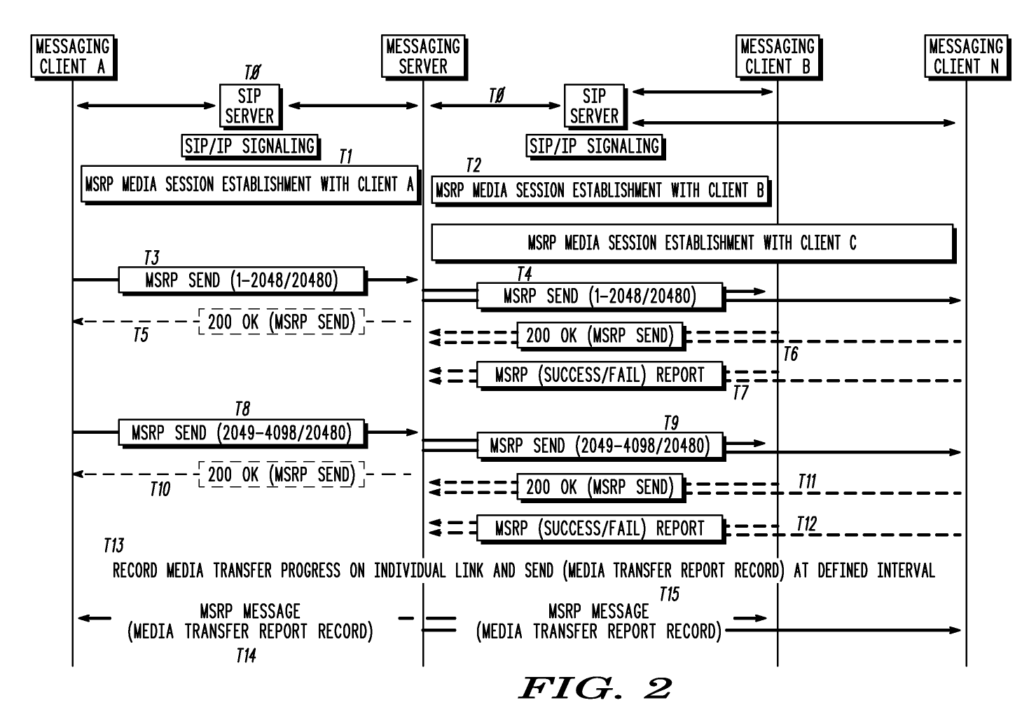

FIG. 2 illustrates a timing diagram for providing a requesting device (sending device and/or receiving device) media transfer status information using MSRP messages, as discussed above. At time T0, SIP/IP signaling is performed by a SIP server between wireless devices 104, 106 and a messaging server such as server 110. At time T1 wireless device A 104 sends a media transfer request to the server 110 and a MSRP media session is established. The server 110, at time T2, also establishes a MSRP media session with the wireless devices that are to receive the data such as wireless device B 106 and wireless device N 108. At time T3 wireless device A 104 sends and MSRP SEND message to the server 110. The server 110, at time T4, sends a MSRP SEND message to each of the receiving devices 106, 108. The server 101, at time T5, sends a 200 OK message to the sending device 104 in response to the MSRP SEND message.

The receiving devices 106, 108, at time T6, send a 200 OK message to the server 100. At time T7, the wireless device B 106 and wireless device N send a MSRP (success/Fail) REPORT to the messaging server. At time T8, the wireless device A 104 sends a MSRP SEND message to the server 110. The server 110, at time T9, sends a MSRP SEND message to each of the receiving devices 106, 108. The server 101, at time T10, sends a 200 OK message to the sending device 104 in response to the MSRP SEND message. The receiving devices 106, 108, at time T11, send a 200 OK message to the server 110. At time T12, the wireless device B 106 and wireless device N 108 send a MSRP (success/Fail) REPORT to the messaging server.

At time T13, the server 110 via its media transfer status module 140 records media transfer progress for each receiving device 106, 108 at a given interval. The server 110, at time T14, sends a MSRP message including a media transfer report record to the sending device 104. The server 110, at time T15, also sends a MSRP message including a media transfer report record to the receiving devices 106, 108. One advantage of various embodiments of the present invention is that MSRP messages are used to facilitate discrete media transfer progress indication.

The data transfer monitor 130 receives transfer status information from the peer devices (i.e., the devices receiving the media). For example, the data transfer monitor receives MSRP REPORT messages received from the peer devices that are associated with MSRP SEND requests sent by the server 110. Media transfer information is then collected from the received messages. These messages comprises information such as message ID, media ID, total size and last segment of data sent/received from each relay link to the server 110, and the like. The periodic media transfer information can be saved (logged) by the data transfer monitor 130. The media transfer information can be post-processed to serve as useful data for statistical analysis of network performance study.

Timing Diagram For Providing Media Transfer Status Using SIP-INFO Messages

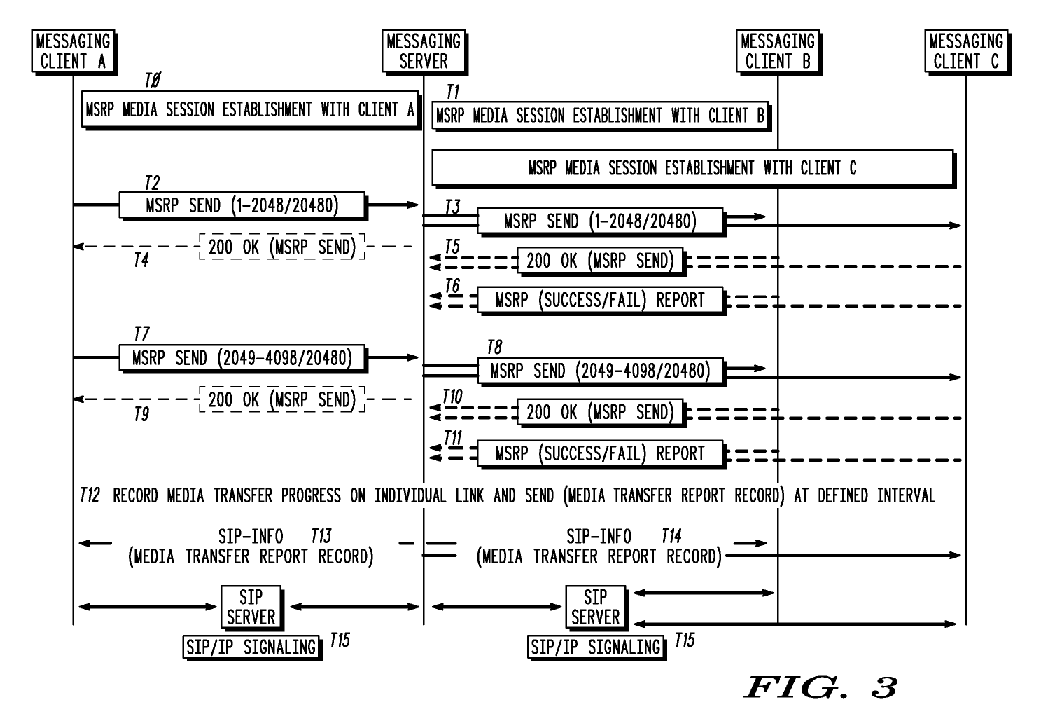

FIG. 3 illustrates a timing diagram for providing a requesting device (sending device and/or receiving device) media transfer status according to another embodiment of the present invention. FIG. 3 shows a timing diagram for sending media transfer status information using SIP-INFO messages. At time T0 wireless device A 104 sends a media transfer request to the server 110 and a MSRP media session is established. The server 110, at time T1, also establishes a MSRP media session with the wireless devices that are to receive the data such as wireless device B 106 and wireless device N 108.

At time T2 wireless device A 104 sends and MSRP SEND message to the server 110. The server 110, at time T3, sends a MSRP SEND message to each of the receiving devices 106, 108. The server 101, at time T4, sends a 200 OK message to the sending device 104 in response to the MSRP SEND message. The receiving devices 106, 108, at time T5, send a 200 OK message to the server 100. At time T6, the wireless device B 106 and wireless device N send a MSRP (success/Fail) REPORT to the messaging server

At time T7 wireless device A 104 sends and MSRP SEND message to the server 110. The server 110, at time T8, sends a MSRP SEND message to each of the receiving devices 106, 108. The server 101, at time T9, sends a 200 OK message to the sending device 104 in response to the MSRP SEND message. The receiving devices 106, 108, at time T10, send a 200 OK message to the server 110. At time T11, the wireless device B 106 and wireless device N 108 send a MSRP (success/Fail) REPORT to the messaging server. At time T2, the server 110 via its media transfer status module 140 records media transfer progress for each receiving device 106, 108 at a given interval. The server 110, at time T13, sends a SIP-INFO message including a media transfer report record to the sending device 104. The server 110, at time T14, also sends a SIP-INFO message including a media transfer report record to the receiving devices 106, 108. At time T15, SIP/IP signaling is performed by a SIP server between wireless devices 104, 106 and a messaging server such as server 110 One advantage of various embodiments of the present invention is that a SIP-INFO message, which usually includes application level information, is extended to facilitate discrete media transfer progress indication. The media transfer status module 140 defines Session Description Protocol (“SDP”) elements to include the media transfer report record 142 in the SIP-INFO message.

The data transfer monitor 130 receives transfer status information from the peer devices (i.e., the devices receiving the media). For example, the data transfer monitor receives MSRP REPORT messages received from the peer devices that are associated with MSRP SEND requests sent by the server 110. Media transfer information is then collected from the received messages. These messages comprises information such as media ID, total size and last segment of data sent/received from each relay link to the server 110, and the like.

Timing Diagram For Providing Media Transfer Status Using MBCP (Media Burst Control Protocol) Messages

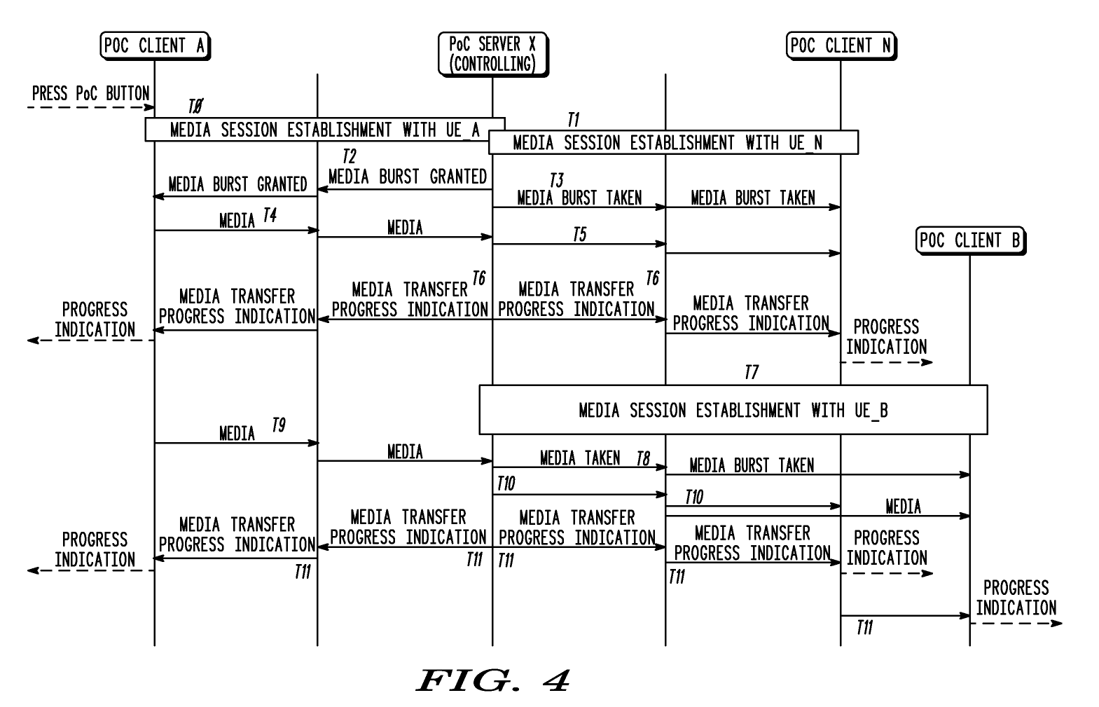

FIG. 4 illustrates a timing diagram for providing a requesting device (sending device and/or receiving device) media transfer status according to another embodiment of the present invention. FIG. 4 shows a timing diagram for sending media transfer status information using a new media burst control message. At time T0 wireless device A 104 establishes a media transfer session with server 110 to transfer media to wireless devices B 106 and N 108. The server 110, at time T1, establishes a transfer media session with the wireless devices that are to receive the data such as wireless device N 108. The server 110, at time T2, sends a message to wireless device A 104, informing it that it has the floor. The server 110, at time T3, sends a message to wireless device N 108, informing it that the floor is taken by wireless device A 104. At time T4 wireless device A 104 sends discrete media to the server 110.

The server 110, at time T5, sends discrete media to wireless device N 108. The server 110, via its media transfer status module 140, uses the information provided by the Real Time Transport Protocol sender information/reception report (“SR/RR”) blocks to evaluate the progress of the media transfer. At time T6, the server 110 sends a media transfer progress indication to wireless devices A 104 and N 108. The server 110, at time T7, establishes a transfer media session with the wireless devices B 106.

The server 110, at time T8, sends a message to wireless device B 106, informing it that the floor is taken by wireless device A 104. At time T9 wireless device A 104 sends discrete media to the server 110. The server 110, at time T10, sends discrete media to wireless devices B 106 and N 108. The server 110, via its media transfer status module 140, uses the information provided by the RTTP SR/RR to evaluate the progress of the media transfer. At time T11, the server 110 then sends a media transfer progress indication to wireless devices A 104, B 106 and N 108.

Timing Diagram For Providing Media Transfer Status Using Event Package (Subscribe/Notify) Messages

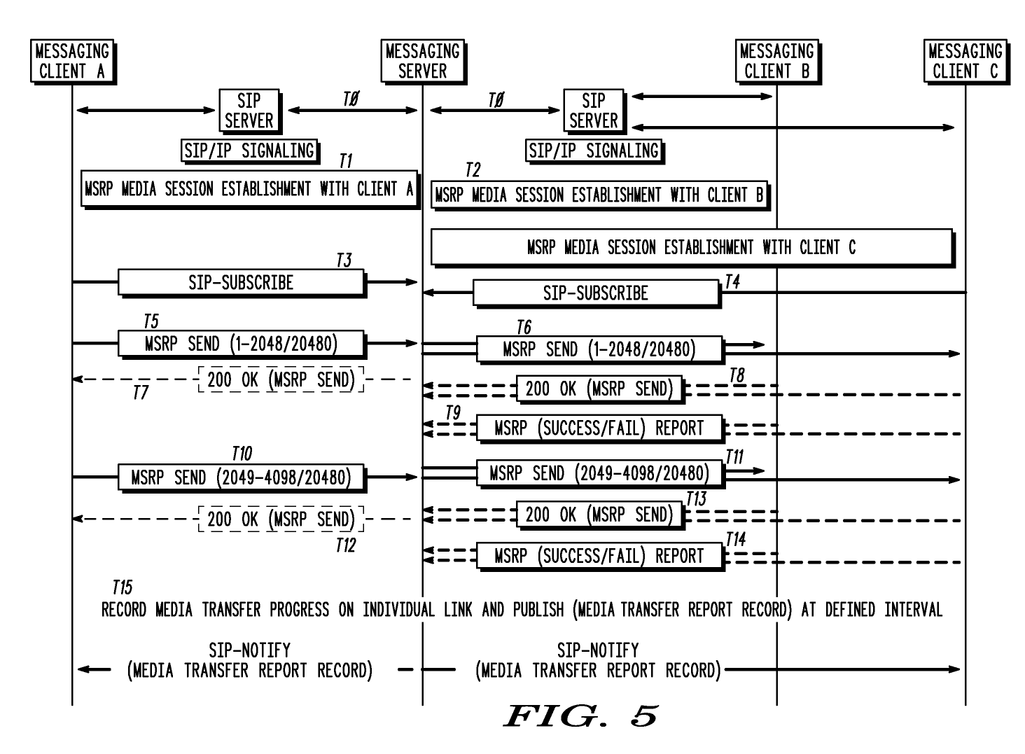

FIG. 5 illustrates a timing diagram for providing a requesting device (sending device and/or receiving device) media transfer status according to another embodiment of the present invention. FIG. 5 shows a timing diagram for sending media transfer status information by creating a new SIP event package and sending a SIP NOTIFY message, which includes progress information to subscribed devices. The media transfer status module 140 creates a SIP event package that records the status of discrete media transfer between the server 110 and recipient devices 106, 108.

At time T0, SIP/IP signaling is performed by a SIP server between wireless devices 104, 106 and a messaging server such as server 110. At time T1 wireless device A 104 sends a media transfer request to the server 110 and a MSRP media session is established. The server 110, at time T2, also establishes a MSRP media session with the wireless devices that are to receive the data such as wireless device B 106 and wireless device N 108. At time T3, wireless device A 104 subscribes to the SIP event package for monitoring media progress/transfer status.

The wireless device A 104 can subscribe to the SIP event package by using the conference URI parameter and/or SIP URI of the originator. At time T4, wireless device B 106 and wireless device N 108 also subscribe to the SIP event package for monitoring media progress/transfer status. At time T5 wireless device A 104 sends and MSRP SEND message to the server 110. The server 110, at time T6, sends a MSRP SEND message to each of the receiving devices 106, 108. The server 101, at time T7, sends a 200 OK message to the sending device 104 in response to the MSRP SEND message. The receiving devices 106, 108, at time T8, send a 200 OK message to the server 100. At time T9, the wireless device B 106 and wireless device N send a MSRP (success/Fail) REPORT to the messaging server.

At time T10, the wireless device A 104 sends and MSRP SEND message to the server 110. For example, the wireless device A 104 sends a discrete media file or content using a MSRP SEND message to the server 110, which forwards a MSRP SEND message to the wireless device B 106 (T11). The server 110, at time T11, sends a MSRP SEND message to each of the receiving devices 106, 108. The server 101, at time T12, sends a 200 OK message to the sending device 104 in response to the MSRP SEND message. The receiving devices 106, 108, at time T13, send a 200 OK message to the server 110.

At time T14, the wireless device B 106 and wireless device N 108 send a MSRP (success/Fail) REPORT to the messaging server. At time T15, the server 110 via its media transfer status module 140 records media transfer progress for each receiving device 106, 108 and publishes a Media Transfer Report record at a given interval. In other words, the server 110 collects and records data transfer status information for each receiving device 106 for each message for which the transfer progress report has been requested in a given session. The server 110, at time T16, sends a SIP NOTIFY message to the wireless devices 104, 106, 108 that have subscribed to the SIP event package. The SIP NOTIFY message includes data transfer status metrics, i.e. the media transfer report record 142 of all the connected links.

Media Transfer Status User Interface

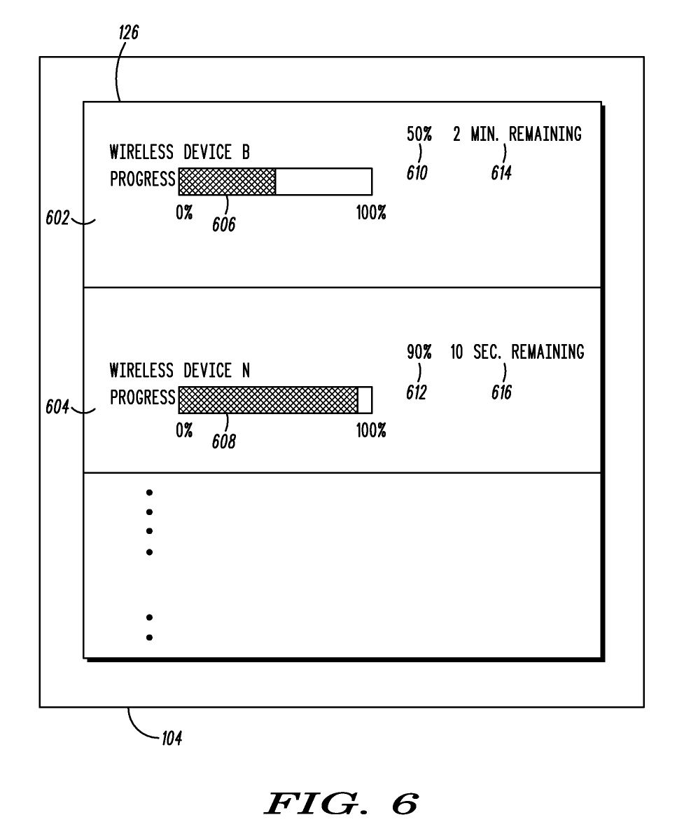

FIG. 6 is a block diagram illustrating one example of a media transfer status user interface 126. It should be noted that the graphical user interface 126 of FIG. 6 is only illustrating and does not limit the present invention. The user interface 126 visually indicates to a user the status of a media transfer to a group of receivers, wherein each receiver in the group is receiving the same media set.

The visually indication can be any combination of colors, shapes, icons, animation, text, pictures, and the like. Audible indication can also be used. The example of FIG. 1 shows the user interface 126 as being on the wireless device A 104 and wireless B 106 and wireless device N 108 as receivers. However, each of the receivers 106, 108 can also include a user interface for displaying media transfer progress of the other receivers. A portion 602, 604 of the user interface 126 displays the media transfer progress for wireless device B 106 and wireless device N 108. Each portion 602, 604 displays a progress bar 606, 608, the current state 610, 612 of the transfer and the time remaining 614, 616 until the transfer is complete. For example FIG. 6 shows that the transfer is at 50% for wireless device B 106 and 90% for wireless device N 108. The user interface 126 also shows that the transfer for wireless device B 106 has 2 minutes remaining and the transfer for wireless device N 108 has 10 seconds remaining. Additional information such as the number of errors encountered by each receiver, the number of retransmissions, and the like can also be displayed.

Wireless Communication Device

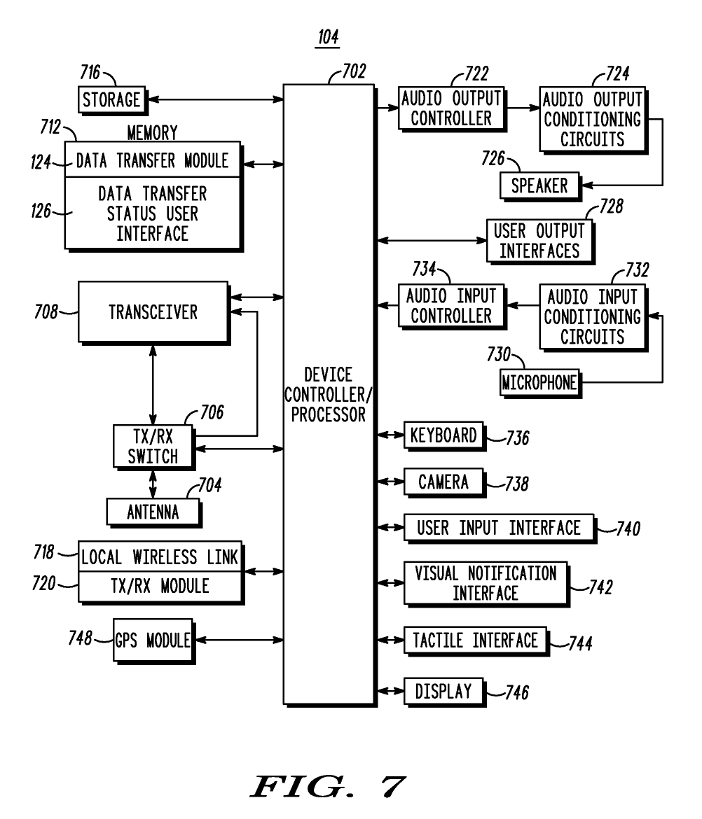

FIG. 7 is a block diagram illustrating a more detailed view of the wireless device 104. The wireless device 104 operates under the control of a device controller/processor 702, that controls the sending and receiving of wireless communication signals. In receive mode, the device controller 702 electrically couples an antenna 704 through a transmit/receive switch 706 to a transceiver 708. The transceiver 708 decodes the received signals and provides those decoded signals to the device controller 702.

In transmit mode, the device controller 702 electrically couples the antenna 704 through the transmit/receive switch 706 to the transceiver 708. The device controller 602 operates the transceiver according to instructions (not shown) stored in the memory 712. These instructions include, for example, a neighbor cell measurement-scheduling algorithm. The memory 712 also includes the data transfer module 124 and the data transfer status user interface 126.

The wireless device 104 also includes non-volatile storage memory 716 for storing, for example, an application waiting to be executed (not shown) on the wireless device 104. The wireless device 104, in this example, also includes an optional local wireless link 718 that allows the wireless device 104 to directly communicate with another wireless device without using a wireless network (not shown). The optional local wireless link 718, for example, is provided by Bluetooth, Infrared Data Access (IrDA) technologies, or the like. The optional local wireless link 718 also includes a local wireless link transmit/receive module 720 that allows the wireless device 104 to directly communicate with another wireless communication device such as wireless communication devices communicatively coupled to personal computers, workstations, and the like.

The wireless device 104 of FIG. 7 further includes an audio output controller 722 that receives decoded audio output signals from the receiver 708 or the local wireless link transmit/receive module 720. The audio controller 722 sends the received decoded audio signals to the audio output conditioning circuits 724 that perform various conditioning functions. For example, the audio output conditioning circuits 724 may reduce noise or amplify the signal. A speaker 726 receives the conditioned audio signals and allows audio output for listening by a user. The audio output controller 722, audio output conditioning circuits 724, and the speaker 726 also allow for an audible alert to be generated notifying the user of a missed call, received messages, or the like. The wireless device 104 further includes additional user output interfaces 728, for example, a head phone jack (not shown) or a hands-free speaker (not shown).

The wireless device 104 also includes a microphone 730 for allowing a user to input audio signals into the wireless device 104. Sound waves are received by the microphone 730 and are converted into an electrical audio signal. Audio input conditioning circuits 732 receive the audio signal and perform various conditioning functions on the audio signal, for example, noise reduction. An audio input controller 734 receives the conditioned audio signal and sends a representation of the audio signal to the device controller 702.

The wireless device 104 also comprises a keyboard 736 for allowing a user to enter information into the wireless device 104. The wireless device 104 further comprises a camera 738 for allowing a user to capture still images or video images into memory 714. Furthermore, the wireless device 104 includes additional user input interfaces 740, for example, touch screen technology (not shown), a joystick (not shown), or a scroll wheel (not shown). In one embodiment, a peripheral interface (not shown) is also included for allowing the connection of a data cable to the wireless device 104. In one embodiment of the present invention, the connection of a data cable allows the wireless device 104 to be connected to a computer or a printer.

A visual notification (or indication) interface 742 is also included on the wireless device 104 for rendering a visual notification (or visual indication), for example, a sequence of colored lights on the display 746 or flashing one or more LEDs (not shown), to the user of the wireless device 104. For example, a received multimedia message may include a sequence of colored lights to be displayed to the user as part of the message. Alternatively, the visual notification interface 742 can be used as an alert by displaying a sequence of colored lights or a single flashing light on the display 746 or LEDs (not shown) when the wireless device 104 receives a message, or the user missed a call.

The wireless device 104 also includes a tactile interface 744 for delivering a vibrating media component, tactile alert, or the like. For example, a multimedia message received by the wireless device 104, may include a video media component that provides a vibration during playback of the multimedia message. The tactile interface 744, in one embodiment, is used during a silent mode of the wireless device 104 to alert the user of an incoming call or message, missed call, or the like. The tactile interface 744 allows this vibration to occur, for example, through a vibrating motor or the like.

The wireless device 104 also includes a display 746 for displaying information to the user of the wireless device 104 and an optional Global Positioning System (GPS) module 748 The optional GPS module 748 determines the location and/or velocity information of the wireless device 104. This module 748 uses the GPS satellite system to determine the location and/or velocity of the wireless device 104. Alternative to the GPS module 748, the wireless device 104 may include alternative modules for determining the location and/or velocity of wireless device 104, for example, using cell tower triangulation and assisted GPS.

Information Processing System

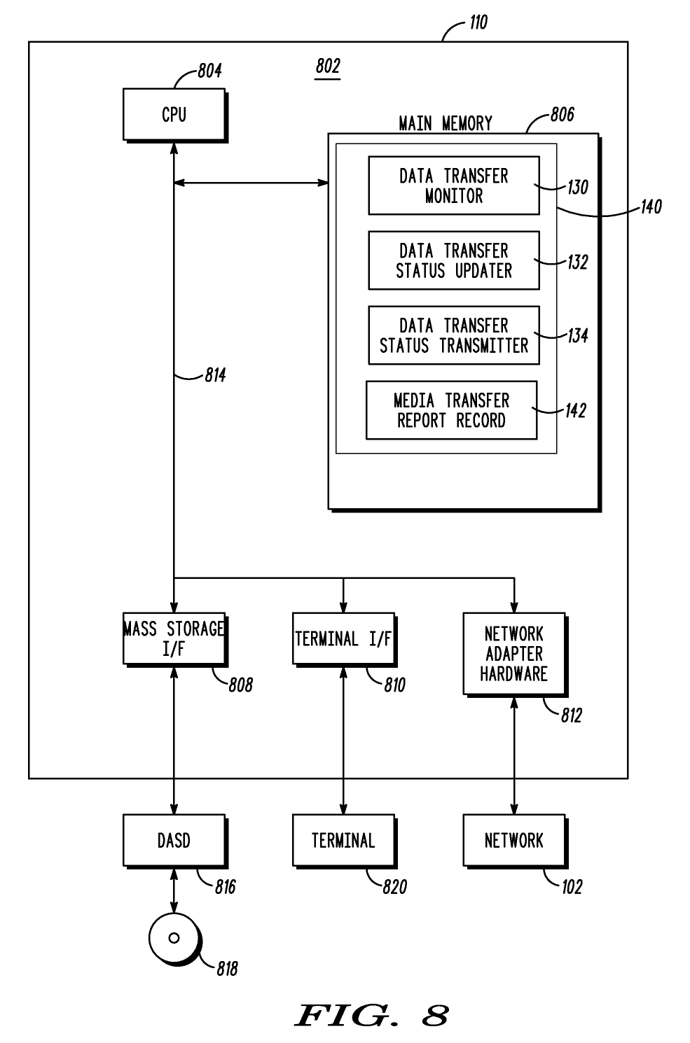

FIG. 8 is a block diagram illustrating a detailed view of the central sever 108 according to an embodiment of the present invention. The site central server 110, in one embodiment, is based upon a suitably configured processing system adapted to implement the embodiment of the present invention. Any suitably configured processing system is similarly able to be used as the central server 110 by embodiments of the present invention, for example, a personal computer, workstation, or the like.

The central server 110 includes a computer 802. The computer 802 has a processor 804 that is communicatively connected to a main memory 806 (e.g., volatile memory), non-volatile storage interface 808, a terminal interface 810, and a network adapter hardware 812. A system bus 814 interconnects these system components. The non-volatile storage interface 808 is used to connect mass storage devices, such as data storage device 816 to the central server 110. One specific type of data storage device is a computer readable medium such as a CD drive, which may be used to store data to and read data from a CD or DVD 818 or floppy diskette (not shown). Another type of data storage device is a data storage device configured to support, for example, NTFS type file system operations.

The main memory 806, in one embodiment, includes the media transfer status module 140. The media transfer status module 140 includes the data transfer monitor 130, data transfer status update 132, data transfer status transmitter 134, and media transfer report record 142. The media transfer status module 140 and its components have been discussed in detail above. Although shown as residing in the memory 806, the data transfer monitor 130, data transfer status update 132, data transfer status transmitter 134 can be implemented in hardware within the central server 110.

In one embodiment, the central server 110 utilizes conventional virtual addressing mechanisms to allow programs to behave as if they have access to a large, single storage entity, referred to herein as a computer system memory, instead of access to multiple, smaller storage entities such as the main memory 806 and data storage device 816. Note that the term “computer system memory” is used herein to generically refer to the entire virtual memory of the central server 110

Although only one CPU 804 is illustrated for computer 802, computer systems with multiple CPUs can be used equally effectively. Embodiments of the present invention further incorporate interfaces that each includes separate, fully programmed microprocessors that are used to off-load processing from the CPU 904. Terminal interface 810 is used to directly connect one or more terminals 820 to computer 802 to provide a user interface to the computer 802. These terminals 820, which are able to be non-intelligent or fully programmable workstations, are used to allow system administrators and users to communicate with the thin client. The terminal 820 is also able to consist of user interface and peripheral devices that are connected to computer 802 and controlled by terminal interface hardware included in the terminal I/F 810 that includes video adapters and interfaces for keyboards, pointing devices, and the like.

An operating system 822, according to an embodiment, can be included in the main memory 806 and is a suitable multitasking operating system such as the Linux, UNIX, Windows XP, and Windows Server 2001 operating system. Embodiments of the present invention are able to use any other suitable operating system, or kernel, or other suitable control software. Some embodiments of the present invention utilize architectures, such as an object oriented framework mechanism, that allows instructions of the components of operating system (not shown) to be executed on any processor located within the client. The network adapter hardware 812 is used to provide an interface to the network 102. Embodiments of the present invention are able to be adapted to work with any data communications connections including present day analog and/or digital techniques or via a future networking mechanism.

Although the embodiments of the present invention are described in the context of a fully functional computer system, those of ordinary skill in the art will appreciate that embodiments are capable of being distributed as a program product via floppy disk, e.g. floppy disk 818, CD ROM, or other form of recordable media, or via any type of electronic transmission mechanism.

Operational Flows For Discrete Media Transfer Progress Indication

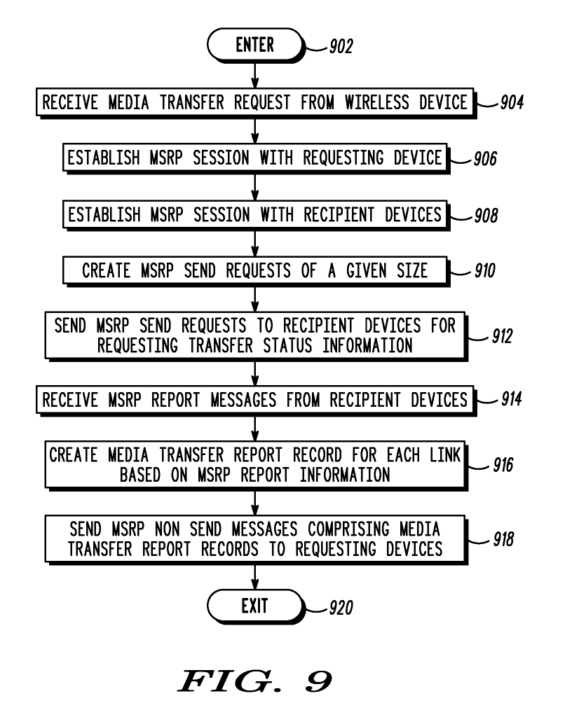

FIG. 9 to FIG. 13 are operational flow diagrams illustrating various processes for discrete media transfer progress indication. FIG. 9 shows an operational flow diagram for indicating the progress of discrete media transfer using MSRP messages. The operational flow diagram of FIG. 9 begins at step 902 and flows directly to step 904. The central server 110, at step 904, receives a discrete media transfer request from a wireless device. The central server 110, at step 906, establishes an MSRP session with the sending device. The central server 110, at step 908, also establishes an MSRP session with the recipient devices.

The central server 110, at step 910, creates MSRP SEND requests of a given size. The MSRP SEND requests, at step 912, are wirelessly transmitted to the recipient devices for requesting discrete media transfer progress information. The central server 110, at step 914, receives MSRP REPORT messages from the recipient devices including discrete media transfer progress information. The central server 110, at step 916, creates media transfer report records for each recipient device based on the MSRP REPORT information. A MSRP (e.g. NON-SEND, REPORT) message, at step 918, is sent to each device (sender and/or recipient) for indicating the transfer progress at each recipient. The control flow then exits at step 920.

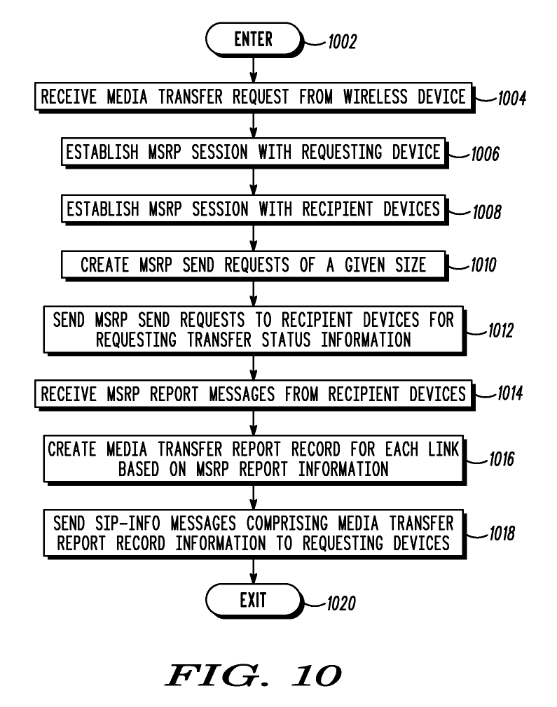

FIG. 10 shows an operational flow diagram for indicating the progress of discrete media transfer using SIP INFO messages. The operational flow diagram of FIG. 10 begins at step 1002 and flows directly to step 1004. The central server 110, at step 1004, receives a discrete media transfer request from a wireless device. The central server 110, at step 1006, establishes an MSRP session with the sending device. The central server 110, at step 1008, also establishes an MSRP session with the recipient devices.

The central server 110, at step 1010, creates MSRP SEND requests of a given size. The MSRP SEND requests, at step 1012, are wirelessly transmitted to the recipient devices for requesting discrete media transfer progress information. The central server 110, at step 1014, receives MSRP REPORT messages from the recipient devices including discrete media transfer progress information. The central server 110, at step 1016, creates media transfer report records for each recipient device based on the MSRP REPORT information. A SIP INFO message, at step 1018, is sent to each device (sender and/or recipient) for indicating the transfer progress at each recipient. The control flow then exits at step 1020.

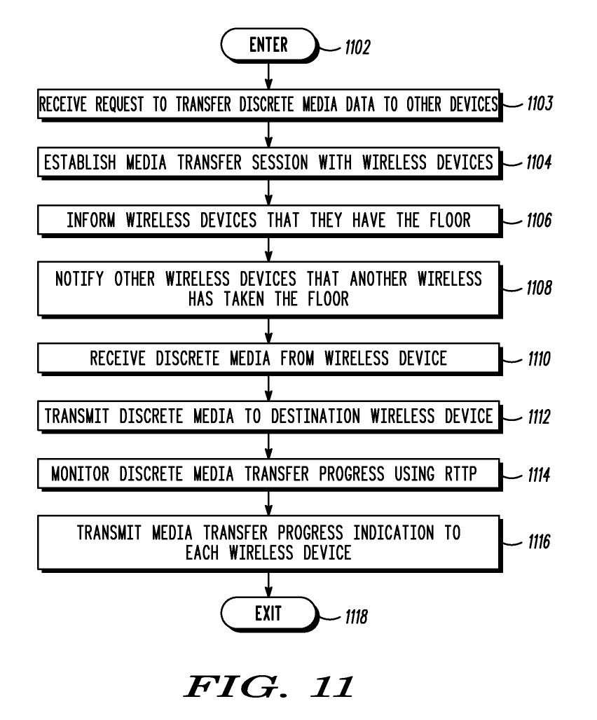

FIG. 11 is an operational flow diagram illustrating a process for indicating the progress of discrete media transfer using media burst control message. The operational flow diagram of FIG. 11 begins at step 1103 and flows directly to step 1104. The server 110, at step 1103, receives a request from a wireless device to transfer discrete media data to other wireless devices 106, 108. The server 110, at time 1104, establishes a media transfer session with one or more wireless devices 106, 108 that are to receive the data. The server, at step 1106, sends a message to one or more wireless devices 104 informing them that they have the floor. The server 110, at step 1108, sends a message the other wireless devices 106, 108 informing them of the wireless devices 104 that have taken the floor. The server, at step 1110, receives discrete media from the wireless device(s) 104 that has taken the floor.

The server 110, at step 1112, sends discrete media to a destination wireless device 106, 108. The server 110, at step 1114, via its media transfer status module 140, uses the information provided by a Real Time Transport Protocol sender information/reception report (“SR/RR”) blocks to evaluate the progress of the media transfer. The server 110, at step 1116, sends a media transfer progress indication to the transmitting and receiving wireless devices 104, 106, 108. The control flow then exits are step 1118.

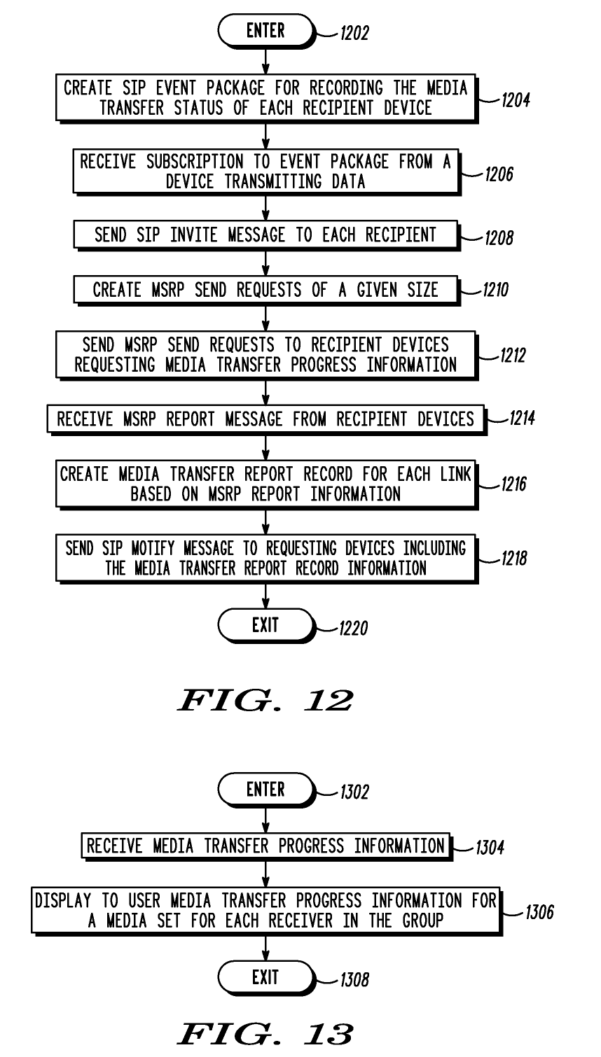

FIG. 12 shows an operational flow diagram for indicating the progress of discrete media transfer using SIP EVENT packages for recording the transfer status of each recipient. The operational flow diagram of FIG. 12 begins at step 1202 and flows directly to step 1204. The central server 110, at step 1204, creates a SIP EVENT package for recording the discrete media transfer progress of each recipient in a group of recipients. The central server 110, at step 1206, receives a subscription to the EVENT package from a sender device. A SIP INVITE message, at step 1208, is sent to each recipient device.

The central server 110, at step 1210, creates MSRP SEND requests of a given size. The MSRP SEND requests, at step 1212, are wirelessly transmitted to the recipient devices for requesting discrete media transfer progress information. The central server 110, at step 1214, receives MSRP REPORT messages from the recipient devices including discrete media transfer progress information. The central server 110, at step 1216, creates media transfer report records for each recipient device based on the MSRP REPORT information. A SIP NOTIFY message, at step 1218, is sent to each device (sender and/or recipient) for indicating the transfer progress at each recipient. The control flow then exits at step 1220.

Process For Displaying Discrete Media Transfer Progress Information T0 a User

FIG. 13 is an operational flow diagram illustrating a process for displaying discrete media transfer information to a user of a sending or receiving device. The operational flow diagram of FIG. 13 begins at step 1302 and flows directly to step 1304. The wireless device 104, 106, 108, at step 1304, receives media transfer progress information via any of the above discussed methods. The graphical user interface 126, at step 1306, displays to a user the transfer progress for each recipient device in a group of devices receiving the same media set. It should be noted that the media transfer progress status information can take many forms. For example, the media transfer progress status information can indicate an anticipated time for completing the media transfer, a completion percentage, number of bytes transferred, failure status and the like. The control flow then exits at step 1308.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with an information processing system, for providing discrete media transfer status information associated with a discrete media transfer event between a discrete media source and at least one discrete media recipient, the method comprising:
receiving a discrete media transfer request from a wireless device comprising discrete media;
receiving a request for discrete media transfer status information;
wirelessly sending a request for discrete media transfer status information to each receiving wireless device in a group of wireless devices receiving the same media set;
receiving discrete media transfer status information from each of the receiving wireless devices;
storing a current transfer status associated with each receiving wireless device based on the discrete media transfer status information received from each receiving wireless device; and
wirelessly sending media transfer status for each receiving wireless device to at least one wireless device in a group of wireless devices sending discrete media and at least one wireless device in the group of receiving wireless devices.

2. The method of claim 1, wherein the request for discrete media transfer status information comprises a media session relay protocol SEND message.

3. The method of claim 1, wherein the request for discrete media transfer status information is negotiated in at least one of a Session Initiation Protocol (“SIP”) message, a Session Description Protocol (“SDP”) message, and headers in at least one Message Session Relay Protocol (“MSRP”) message.

4. The method of claim 1, wherein the discrete media transfer status information is received from each receiving wireless device in an MSRP protocol REPORT message.

5. The method of claim 1, wherein the wirelessly sending media transfer status is based on a delivery interval defined by at least one of a local policy of a network service provider, at least one wireless device in the set of wireless devices sending discrete media, and at least one wireless device in the group of receiving wireless devices.

6. The method of claim 1, wherein the storing a current transfer status, further comprises:
creating media transfer report record for each receiving wireless device, wherein the media transfer report record comprises at least current transfer status information for a receiving wireless device associated with the media transfer report record; and
creating optimized media transfer report record for all receiving wireless devices, wherein the media transfer report record comprises at least one of the following information sets:
lowest percentage of discrete media transfer completed;
number of transfers in progress;
number of failed transfers; and
number of completed transfers.

7. The method of claim 6, further comprising:
utilizing the stored media transfer report records for post-processing to serve as useful data for statistical analysis of network performance study.

8. The method of claim 1, wherein the wirelessly sending further comprises:
wirelessly sending the media transfer status information in a media session relay protocol message.

9. The method of claim 1, wherein the wirelessly sending further comprises:
wirelessly sending the media transfer status information in a SIP-INFO message.

10. The method of claim 1, wherein the wirelessly sending further comprises:
wirelessly sending the media transfer status information in a Media Burst Control Protocol message comprising a media transfer progress status indication message.

11. The method of claim 1, further comprising:
creating a SIP EVENT package for monitoring the transfer status of each receiving wireless device; and
receiving a request from at least the wireless device to subscribe to the SIP EVENT package,
wherein the wirelessly sending further comprises wirelessly sending the transfer status information to at least the wireless device in a SIP NOTIFY message.

12. A method, with a wireless device, for displaying discrete media transfer progress for each wireless device in a group of wireless devices receiving a substantially similar media set, the method comprising:
receiving discrete media transfer progress status information associated with a plurality of wireless devices receiving a substantially similar media set; and
displaying to a user through a user interface discrete media transfer progress status information for each wireless device in the plurality of wireless devices.

13. An information processing system for providing discrete media transfer status information associated with a discrete media transfer event between a discrete media source and at least one discrete media recipient, the information processing system comprising:
a memory;
a processor communicatively coupled to the memory; and
a media transfer status module communicatively coupled to the memory and the processor, the media transfer status module for:
receiving a discrete media transfer request from a wireless device comprising discrete media;
receiving a request for discrete media transfer status information;
wirelessly sending a request for discrete media transfer status information to each receiving wireless device in a group of wireless devices receiving the same media set;
receiving discrete media transfer status information from each of the receiving wireless devices;
storing a current transfer status associated with each receiving wireless device based on the discrete media transfer status information received from each receiving wireless device; and
wirelessly sending media transfer status for each receiving wireless device to at least one wireless device in a set of wireless devices sending discrete media and at least one wireless device in the group of receiving wireless devices.

14. The information processing system of claim 13, wherein the discrete media transfer status information is received from each receiving wireless device in a media session relay protocol REPORT message.

15. The information processing system of claim 13, wherein the wirelessly sending media transfer status is based on a delivery interval defined by at least one of a local policy of a network service provider, at least one wireless device in the set of wireless devices sending discrete media, and at least one wireless device in the group of receiving wireless devices.

16. The method information processing system of claim 13, wherein the storing a current transfer status, further comprises:
creating media transfer report record for each receiving wireless device, wherein the media transfer report record comprises at least current transfer status information for a receiving wireless device associated with the media transfer report record; and
creating optimized media transfer report record for all receiving wireless devices, wherein the media transfer report record comprises at least one of the following information sets:
lowest percentage of discrete media transfer completed;
number of transfers in progress;
number of failed transfers; and
number of completed transfers.

17. The information processing system of claim 13, wherein the wirelessly sending further comprises:
wirelessly sending the media transfer status information in a media session relay protocol message.

18. The information processing system of claim 13, wherein the wirelessly sending further comprises:
wirelessly sending the media transfer status information in a SIP-INFO protocol message.

19. The information processing system of claim 13, wherein the wirelessly sending further comprises:
wirelessly sending the media transfer status information in a Media Burst Control Protocol message comprising a media transfer progress indication status message.

20. The information processing system of claim 13, further comprising:
creating a SIP EVENT package for monitoring the transfer status of each receiving wireless device; and
receiving a request from at least the wireless device to subscribe to the SIP EVENT package,
wherein the wirelessly sending further comprises wirelessly sending the transfer status information to at least the wireless device in a SIP NOTIFY message.
